(19) United States
(12) Patent Application Publication
(10) Pub. No.: US 2025/0212299 A1
(43) Pub. Date: Jun. 26, 2025

(54) MONITORING SYSTEM FOR AN ELECTRODE COUPLING DEVICE

(71) Applicant: GRAFTECH INTERNATIONAL HOLDINGS INC., Brooklyn Heights, OH (US)

(72) Inventors: William J. MacDonald, Ridgway, PA (US); Carl R. Schwabe, Waynetown, IN (US); Ryan Thomas Kopacko, Summerville, SC (US)

(21) Appl. No.: 18/989,392

(22) Filed: Dec. 20, 2024

Related U.S. Application Data
(60) Provisional application No. 63/613,198, filed on Dec. 21, 2023.

(51) Int. Cl. H05B 7/14; F27B 3/08; G01L 5/24; H05B 7/18

(52) U.S. Cl. CPC H05B 7/14; G01L 5/24; H05B 7/18; F27B 3/085

(57) ABSTRACT

An electrode coupling monitoring system for use with a device configured to apply torque to a first electrode to threadedly couple the first electrode to a second electrode. The device is configured to output torque values relating to an applied torque. The system includes a controller configured to receive torque values and analyze the received torque values to identify a thread engagement phase during which the first electrode is or was being threadedly coupled to the second electrode. The controller is also configured to identify an end face engagement phase during which an end face of the first electrode contacts or contacted an end face of the second electrode.

This application claims priority to U.S. Provisional Application Ser. No. 63/613,198 entitled Monitoring System for an Electrode Coupling Device, filed on Dec. 21, 2023, the entire contents of which are hereby incorporated by reference.

The present disclosure relates to a monitoring system for use with a device for coupling electrodes, and more particularly to such a monitoring system for detecting when the electrodes are/are not properly coupled.

### BACKGROUND

Electrode coupling devices can be used to couple two electrodes together, for example by threading the electrodes together. Once the electrodes are coupled together to form an electrode column, the electrode column can be mounted in an electric arc furnace. When coupling the electrodes together, it is desired for the coupling to be secure and complete. In particular, incomplete or faulty couplings can lead to poor performance of the electrodes and can also lead to fracturing or breaking of the electrodes during use of the electrodes. Such poor performance, fracturing and/or breaking can result in reduced performance and/or complete shutdown of the furnace, which can lead to significant loss of revenue for the furnace operator.

### SUMMARY

In one embodiment, the disclosure is directed to an electrode coupling monitoring system for use with a device configured to apply torque to a first electrode to threadedly couple the first electrode to a second electrode. The device is configured to output torque values relating to an applied torque. The system includes a controller configured to receive torque values and analyze the received torque values to identify a thread engagement phase during which the first electrode is or was being threadedly coupled to the second electrode. The controller is also configured to identify an end face engagement phase during which an end face of the first electrode contacts or contacted an end face of the second electrode.

Certain embodiments of the present disclosure relate to systems, methods, and/or computer-readable storage media for an electrode coupling monitoring system for use with a device configured to apply torque to a first electrode to threadedly couple the first electrode to a second electrode, where the device is configured to output torque values relating to the applied torque. These and other embodiments can each optionally include one or more of the various features described below.

In accordance with some implementations, a non-transitory computer readable storage medium has stored therein instructions that are computer-executable to perform or cause performance of any of the methods described herein. In accordance with some implementations, a device includes one or more processors, a non-transitory memory, and one or more programs; where the one or more programs are stored in the non-transitory memory and configured to be executed by the one or more processors, and where the one or more programs include instructions for performing or causing performance of any of the methods described herein.

### BRIEF DESCRIPTION OF THE DRAWINGS

FIG. 1 is a perspective view of a pair of spaced-apart electrodes;

FIG. 2 is a schematic representation of an electrode coupling device, shown in conjunction with the electrodes of FIG. 1, in an uncoupled position;

FIG. 3 shows the system of FIG. 2, with the electrodes initially coupled together in the axial direction;

FIG. 4 shows the system of FIG. 3, with the electrodes being rotated relative to each other to further couple the electrodes together;

FIG. 5 shows the system of FIG. 4, with the electrodes fully coupled together;

FIG. 6 shows the electrodes of FIGS. 1-5, coupled together to form an electrode column;

FIG. 7 is a graph showing a representation of applied pressure/torque of the device of FIG. 2, in an exemplary proper coupling of electrodes;

FIG. 8 is a graph showing a representation of applied pressure/torque of the device of FIG. 2, in another exemplary proper coupling of electrodes;

FIG. 9 is a graph showing a representation of applied pressure/torque of the device of FIG. 2, in a faulty coupling of electrodes;

FIG. 10 is a graph showing a representation of applied pressure/torque of the device of FIG. 2, in another faulty coupling of electrodes;

FIG. 11 is a graph showing a representation of applied pressure/torque of the device of FIG. 2, in yet another faulty coupling of electrodes;

FIG. 12 is a flowchart showing an overview of a system and method for monitoring electrode couplings;

FIG. 13 is a flowchart showing more detailed implementation of an example of a system and method for monitoring electrode coupling; and

FIG. 14 is a block diagram illustrating device components of an exemplary device according to certain implementations.

It should be noted that the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

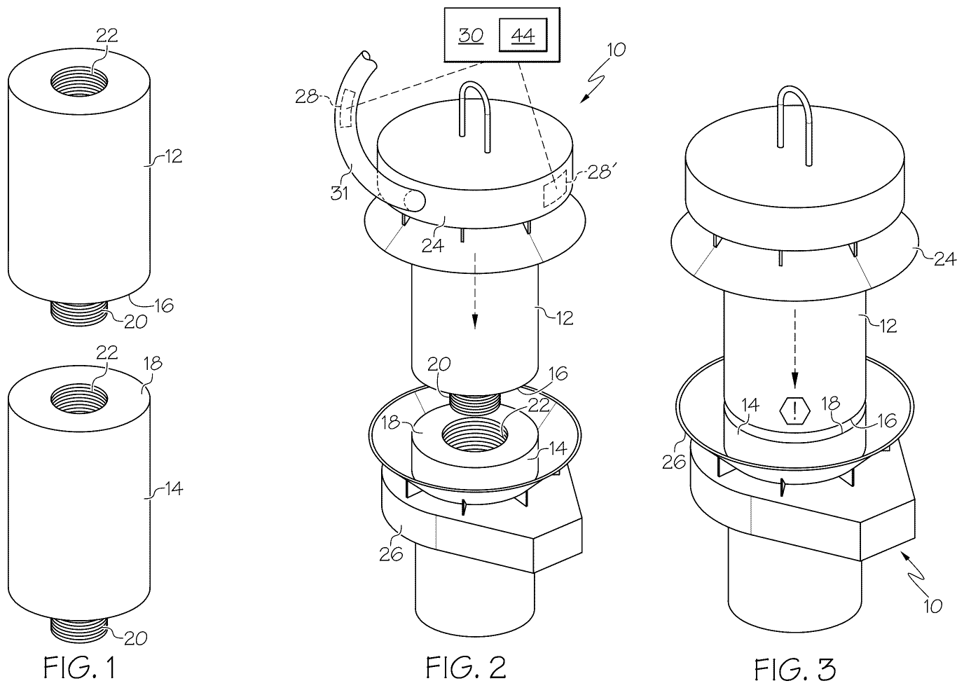

With reference to FIGS. 1-6, the system and method disclosed herein can include and/or be used in conjunction with a coupling device 10 that is configured to couple together a first electrode 12 and a second electrode 14. The first 12 and second 14 electrodes can, in one case, be generally cylindrical, with each having a respective facing axial end face 16, 18. The first electrode 12 has a threaded pin 20 at/on its end face 16. The pin 20 can be integrally formed with the electrode 12, or alternatively can be a separate component that is threaded into the first electrode 12. The second electrode 14 has a corresponding threaded socket 22 on/at the axial end face 18. In the illustrated embodiment the pin 20 and socket 22 are both generally frustoconical and threaded on their outer/inner surfaces, respectively. The pin 20 is thereby configured to be threadedly coupled to the socket 22 to couple the first 12 and second 14 electrodes together. Alternatively, the position of the pin 20 and socket 22 can be reversed such that the pin 20 is on the second electrode 14, and the socket 22 is on the first electrode 12.

The coupling device 10 can include a pair of gripping portions 24, 26, each of which is configured to grip one of the electrodes 12, 14. At least one of the gripping portions 24, 26 (rotational gripping portion 24, in the illustrated embodiment) is configured to rotate relative to the other electrode 12, 14/gripping portion 24, 26 about a central axis of the electrodes 12, 14/gripping portions 24, 26. At least one of the gripping portions 24, 26 is also configured to move in the axial direction to enable coupling of the electrodes 12, 14 together. The rotational gripping portion 24 can have a torque applied thereto by a motive force, such as a pneumatic fluid, an electrical current, or other power/torque sources, such that the rotational gripping portion 24 can in turn apply a torque to the gripped electrode 12.

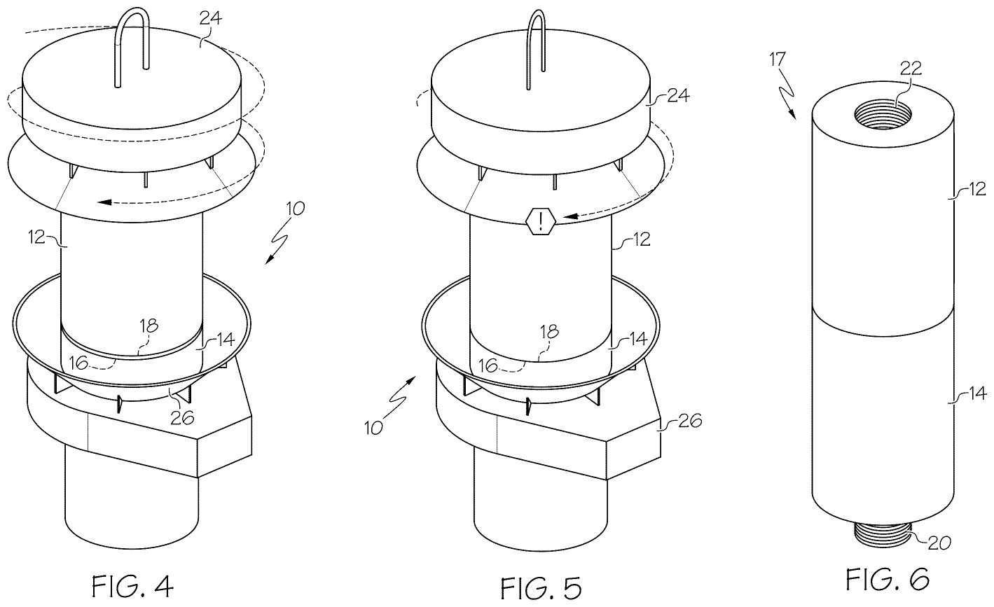

In order to use the coupling device 10 and couple the electrodes 12, 14 (also termed an electrode add process), the first electrode 12 is gripped by the gripping portion 24 and lifted by the gripping portion 24, and/or lifted by a separate hoist, crane, lift or other lifting component. The first electrode 12 is then positioned such that the pin 20 of the first electrode 12 is axially aligned with the socket 22 of the second electrode 14, as shown in FIG. 1. The first electrode 12 is then lowered until the pin 20 is loosely received in the socket 22, as shown in FIG. 3. The gripping portion 24 is then rotated about a central axis of the electrodes 12, 14, which in turn causes the pin 20 to be threaded into the socket 22. Once the pin 20 is fully threaded into the socket 22, as shown in FIG. 4, the end faces 16, 18 of the electrodes 12, 14 abut against each other in a plane-to-plane contact, and the pin 20 cannot be further threaded into the socket 22 and the electrodes 12, 14 are considered to be fully, and properly, coupled.

Operation of the electrode coupling device 10 is typically implemented manually. In particular an operator can trigger the rotational gripping portion 24 to rotate by triggering a switch, allowing or enabling the motive force to apply a torque to the electrode 12, thereby threading the pin 20 into the socket 22. The (human, in one case) operator observes the threading process, and once the operator observes and/or senses that the pin 20 is fully threaded into the socket 22 (e.g. due to visual confirmation, and/or audio cues, such as hearing the end faces 16, 18 abut each other, or hearing the motive force having to work harder), the operator can turn off the power/motive force, causing the rotational gripping portion 24 to stop rotating. Once threading operations are completed, the end faces 16, 18 of the electrodes 12, 14 abut against each other. The operator is then typically desired to then “bump” the electrode 12 by triggering the coupling device 10 with a series (typically two-three) of briefly applied torques to the rotationally gripping portion 24 to ensure that the first 12 and second 14 electrodes are fully and properly coupled.

When the first 12 and second 14 electrodes are coupled together, they together form an electrode column 17 as shown in FIG. 6 (or are coupled to an existing electrode column, including other electrodes (not shown)). The electrode column 17 is then positioned in, or forms part of, an electric arc furnace. Once mounted into the furnace, electricity is passed through the electrode column 17, and any other electrode columns of the electric arc furnace, to generate high temperatures to, for example, melt metals or other materials for further processing.

Each electrode 12, 14 can be substantially or primarily made of carbon and/or a carbonaceous material (e.g. comprise at least 80% in one case, or at least 90% in another case, or carbon and/or carbonaceous material by weight and/or volume). In one case each electrode 12, 14 is substantially or primarily (e.g. at least 80% in one case, or at least 90% in another case by weight/or volume) made of graphite such as a graphitized mixture of coke, for example needle coke, calcined petroleum coke, calcined anthracite, and a binder, such as for example pitch, coal tar pitch or petroleum pitch, that is formed, baked, impregnated, graphitized and machined. Each electrode 12, 14 may be relatively electrically conductive, and able to accommodate electrical currents densities in excess of 20 A/cm² in one case, or in excess of 30 or 35 A/cm² in another case, while retaining its shape and dimensional properties. The electrical resistivity of the electrodes 12, 14 in one case is greater than about 2 micro-Ohm*meter, and in another case is less than about 20 micro-Ohm*meter.

Each electrode 12, 14 may be able to be heated to temperatures of at least about 2,800° C. in one case, or at least about 3,000° C. in another case, or at least about 3200° C. in yet another case while retaining its shape and dimensional properties, and while remaining electrically conductive. U.S. Pat. No. 10,237,928, the entire contents of which are hereby incorporated by reference herein, discloses electrodes and methods for making such electrodes, which materials and methods can be used to make the electrodes 12, 14 described herein.

The electrode coupling device 10 can be configured to sense/measure the torque applied by the coupling device 10/rotational gripping portion 24 to the electrode 12 via one or more sensors, schematically shown as sensors 28, 28′ in FIG. 2. In one case, when the electrode coupling device 10 is pneumatically driven the electrode coupling device 10 can have a hydraulic supply line 31. In this case the sensor 28 can be located on/in the supply line 31 and the sensor 28 can sense a pressure of the working/pneumatic fluid, which can be directly proportional (or have some other known/predictable relationship) to the torque applied by the gripping portion 24 and/or to the gripped electrode 12. In another case, where the coupling device 10 is electrically powered, the supply line 31 can be a cord/electrical conductor, and the sensor 28 can sense current and/or voltage flowing to/applied to the coupling device 10 and/or to the gripping portion 24 which can be directly proportional (or have some other known relationship) to the torque applied to the electrode 12. In yet another case, sensor 28′ can be located on/in the gripping portion 24 itself to detect the applied torque.

The sensor 28, 28′ can thus provide an output that is related and to and/or indicative of torque applied by the coupling device 10/gripping portion 24. When the coupling device 10/gripping portion 24 is being operated but is not threading the electrodes 12, 14 together (e.g. during the steps shown in FIGS. 2 and 3), the output of the sensor 28, 28′ is expected to be relatively low, and can be zero, or effectively zero (negligible values). In contrast, when the coupling device 10/gripping portion 24 is threading the electrodes 12, 14 together (e.g. during the step shown in FIG. 4), the measured torque is expected to be greater than zero, but still a relatively low value. Finally, when threading is complete and the end faces 16, 18 abut against each other (e.g. during the step shown in FIG. 5), but the coupling device 10 is still being operated, the measured/output torque is expected to be relatively high, since the electrodes 12, 14 resist further rotation and the applied torque therefore significantly increases.

The sensor 28, 28′ can be operatively coupled to a controller, generally designated 30, such that the output of the sensor 28, 28′ (e.g. measurement of the pressure, current, voltage or any other quantity indicative of applied torque) is provided to the controller 30. The output of the sensor 28 can be considered to be a “torque value” even when the output is not necessarily provided in torque units (e.g. lb.-ft). The controller 30 can take any of a wide variety of forms, but in one case is a controller, processor, computer, CPU or the like (together, termed a “controller”) that has a memory and non-transitory, computer readable program instructions thereon for causing the controller 30 to carry out the steps and processes set forth below.

The controller 30 is configured to receive the output from the sensor(s) 28, 28′ (e.g. the data or torque values) and analyze the received data/torque values to determine when the electrodes 12, 14 have been properly and/or improperly coupled. In particular, the controller 30 is configured to analyze the received torque values to identify a Thread Engagement Phase 32 during which the first electrode 12 is being threadedly coupled to the second electrode 14 (as shown in FIG. 4). The controller 30 is also configured to identify an End Face Engagement Phase 34 during which an end face 16 of the first electrode 12 contacts the end face 18 of the second electrode 14 and/or the first 12 and second 14 electrodes are fully threadedly coupled (as shown in FIG. 5).

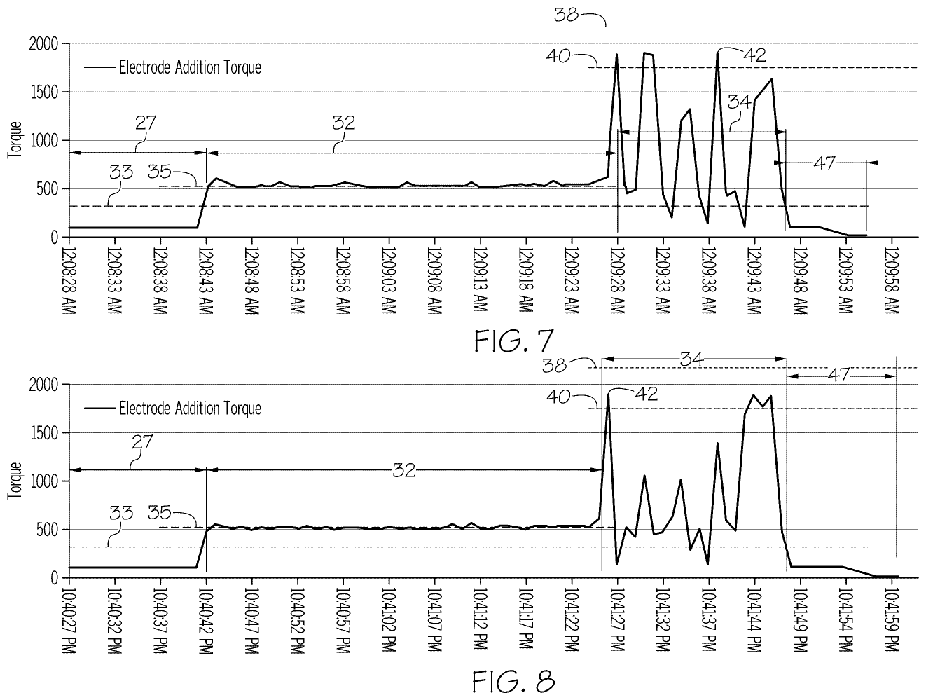

FIGS. 7 and 8 provide exemplary graphs of the output of the sensor(s) 28 during a proper coupling of the electrodes 12, 14. In those figures, the vertical axis denotes measured pressure (in psi) applied by the coupling device 10 (for example when the rotational gripping portion 24 has a torque applied thereto by a pneumatic fluid), which as noted above can be considered to be directly related to applied torque values (in lb.-ft). The horizontal axis denotes time (broken down into seconds, in the illustrated embodiment).

At beginning of the electrode coupling process, at phase 27 of FIGS. 7 and 8, the pressure/torque values are relatively low and steady, at or close to zero, and the pin 20 and the socket 22 are not engaged and/or are not in contact (which can be termed the Pre-Thread Engagement Phase 27). Then, as the pin 20 engages the socket 22 and is threadedly coupled into the socket 22, the pressure/torque values increase significantly, but remain relatively constant (at a pressure of around 500 psi in FIGS. 7 and 8). Thus, once the pressure/torque value exceeds a predetermined value/threshold, termed the Minimum Pressure/Torque Value 33 (about 300 psi in the embodiment of FIGS. 7 and 8), and in one case remains relatively constant thereafter and/or exceeds the Minimum Pressure/Torque Value 33 for a predetermined period of time, the system is determined to have exited the Pre-Thread Engagement Phase 27, and to have entered the Thread Engagement Phase 32 (at a time of about 12:08:43 AM in the embodiment of FIG. 7, and a time of about 10:40:42 PM in the embodiment of FIG. 8).

The system/controller 30 is thus configured to identify the system as entering or being in the Thread Engagement Phase 32 when pressure/torque values are maintained at a value above the Minimum Pressure/Torque Value 33, but still maintained at relatively low, relatively steady state torque values (in one case, below the End Face Threshold Pressure/Torque 40, as will be described in greater detail below) for a predetermined period of time (or within a predetermined period of time, e.g. at least about ten second in one case, or at least about twenty seconds in one case, and at least about thirty seconds in another case). The measured pressure/torque values are expected to remain relatively constant during the Thread Engagement Phase 32 during a proper threading/coupling, and the system is essentially in a steady state.

The system/controller 30 can be configured to identify the End Face Engagement Phase 34 by determining that the pressure/torque values reach relatively high values after commencement of the Thread Engagement Phase 32. In particular, the coupling device 10 can have a Nominal Maximum Pressure/Torque 38 (maximum torque), which is the upper value of the pressure/torque that can be applied by the coupling device 10. When the measured pressure/torque values sufficiently approach the Nominal Maximum Pressure/Torque 38, the system/controller 30 can determine that the system/process has exited the Thread Engagement Phase and entered the End Face Engagement Phase 34. In one case, when the measured pressure/torque values are within 10% in one case, or within 20% in another case, or within 30% in another case, or within 40% in yet another case, of the Nominal Maximum Pressure/Torque 38, the system can be determined to be in the End Face Engagement Phase 34.

In the embodiment of FIGS. 7 and 8, the Nominal Maximum Pressure/Torque 38 can be set at and/or assumed to be about 2150 psi, and the threshold psi for entering the end face engagement phase (the End Face Threshold Pressure/Torque 40) is set at 1750 psi (about 18.6% of the Nominal Maximum Pressure/Torque 38 in this case). Thus, in the embodiment of FIG. 7 the system is determined to have entered the End Face Engagement Phase 34 (and to have exited the Thread Engagement Phase 32) at a time of about 12:09:28 AM. In the embodiment of FIG. 8 the system is determined to have entered the End Face Engagement Phase 34 at a time of about 10:41:26 PM. The system/controller 30 can then (or at a later time) calculate a Thread Engagement Time, which is the amount of time the system was in the Thread Engagement Phase 32 (about forty-five seconds in the embodiment of FIG. 7, and about forty-four second in the embodiment of FIG. 8). The system/controller 30 can also be configured to determine an average pressure/torque applied during the Thread Engagement Phase 32 (the Thread Engagement Phase Average Pressure/Torque 35; about 550 psi in the embodiment of FIG. 7 and about 520 psi in the embodiment of FIG. 8)

During the End Face Engagement Phase 34, the measured pressure/torque may peak several times, as shown in FIGS. 7 and 8, as the operator applies power to the coupling device 10 for short periods of time, in several “bumps” to ensure the threaded surfaces 20, 22 are fully engaged, resulting in several short peaks of pressure/torque. When the operator is satisfied that there is sufficient coupling, the operator reduces and/or terminates power to the electrode coupling device 10, and the measured pressure/torque falls below the Minimum Pressure/Torque Value 33 (about 300 psi in the illustrated embodiment), and enters the Shut-Down Phase 47.

When the measured pressure/torque value remains below the Minimum Pressure/Torque Value 33 for a predetermined period of time (for example, ten seconds in one case), the End Face Engagement Phase 34 can be determined to have ended (e.g. “back-dated” or “back-timed”) to the time when the pressure, in the End Face Engagement Phase 34, first fell below the Minimum Pressure/Torque Value 33, and remained below the Minimum Pressure/Torque Value 33 for that predetermined period of time. A minimum time requirement (such as ten seconds in one embodiment) can be useful to ensure that the End Face Engagement Phase 34 is not determined to have been exited prematurely, since the measured torque values can fall relatively low (below the Minimum Pressure/Torque Value 33) immediately after a bump as shown in the End Face Engagement Phases 34 of FIGS. 7 and 8. Thus, in the embodiment of FIG. 7 the system is determined to have exited the End Face Phase 34, and entered the Shut-Down Phase 47 at a time of about 12:09:46 AM. In the embodiment of FIG. 8 the system is determined to have exited the End Face Phase 34, and entered the Shut-Down Phase 47 at a time of about 10:41:48 PM.

The system/controller 30 can then (or at a later time) calculate an End Face Engagement Time, which is the amount of time the system was in the End Face Engagement Phase 34 (about eighteen seconds in the embodiment of FIG. 7, and about twenty two seconds in the embodiment of FIG. 8). The system/controller 30 can then (or at later time) calculate a Total Build Time, which is the Thread Engagement Phase Time plus the End Face Engagement Time (sixty three seconds in the embodiment of FIG. 7, and sixty six seconds in the embodiment of FIG. 8). The system/controller 30 can also track/determine a Maximum End Face Phase Pressure/Torque 42, which is the maximum pressure/torque applied/sensed during the End Face Engagement Phase 34 (about 1950 psi in the embodiments of FIG. 7 and FIG. 8).

The system/controller 30 can be configured to determine and store predetermined values/thresholds and calculated/tracked values of the electrode coupling process, including all those values/thresholds described above and also those which will be described below, such as pressure/torque values, upper and lower ranges, Thread Engagement Time, End Face Engagement Time, Total Build Time, Thread Engagement Phase Average Pressure/Torque, Maximum End Face Phase Pressure/Torque 42, etc. and average, median and standard deviations thereof, in a Historical Database 44. Such values can be collected and stored during a calibration period where the electrode coupling process is closely monitored to ensure proper electrode coupling, and the data from such proper couplings are stored in the Historical Database 44.

A distribution of the values, and/or a mean and/or median of the relevant values can also be calculated and/or stored in the Historical Database 44. The Historical Database 44 can also include other information relating to the electrodes 12, 14 and/or coupling process, including in one case the name or other identification of the owner/operator of the electrodes 12, 14 and the associated furnace, the name or other identification of the associated furnace, heat number or other identification relating to a heat cycle using certain electrodes 12, 14, start time of the build/coupling process, end time of the build/coupling process, etc.

The values in the Historical Database 44 can be updated over time, with values for proper electrode couplings being added into the Historical Database 44 over time, where the “proper electrode couplings” can be determined by the system/controller and/or the user, including in some cases using the parameters outlined below. On the other hand, data from improper/faulty couplings can be excluded from the Historical Database 44, in certain cases as outlined below.

New values that are added to the Historical Database 44 can be weighted more heavily, less heavily, or equally, as compared to older values, depending upon operator preferences. In some cases, the Historical Database 44 can only include data from relatively recent couplings; e.g. those occurring within the last ninety days in one case, or those occurring within the last forty five days in another case, or those occurring within the last fifteen days in yet another case. The Historical Database 44 can also exclude data from very recent couplings if desired, for example, from couplings conducted the same day as the electrode coupling under consideration. The Historical Database 44 can be maintained on a device-by-device basis; that is, each electrode coupling device 10 can have its own Historical Database 44, and/or data can be aggregated if desired.

Improper or faulty coupling of the electrodes 12, 14 can have various causes, such as a foreign body/obstruction in the socket 22 and/or on the pin 20, cross threading of the pin 20/socket 22, defective or misaligned threads, or operator error. The system/controller 30 can be configured to monitor the electrode coupling process to determine if there is improper coupling, and if so, send a notification (e.g. to the operator of the coupling device 10, or to a remote entity/controller, or elsewhere), and/or to automatically stop the coupling process (e.g. in one case block any further operation of the coupling device 10/gripping portion 24). Upon notification of an improper coupling the operator can take various actions at the operator's choice, such as retrying the coupling, or stopping the coupling and inspecting the electrodes 12, 14/threaded surfaces 20, 22, cleaning the electrodes 12, 14/threaded surfaces 20, 22, or taking other corrective measures, or discarding one or both electrodes 12, 14. By detecting faulty or potentially faulty electrode couplings, the system and method disclosed herein can give the operator the opportunity to take corrective action prior to placing the electrodes 12, 14/electrode column 17 into the furnace.

### Thread Engagement Phase Threshold

In one case measured pressure/torque during the Thread Engagement Phase 32 is monitored, and if the measured pressure/torque sufficiently differs from a predetermined limit, the system/controller 30 can determine that the electrodes 12, 14 may be improperly coupled. More particularly, if the measured pressure/torque value sufficiently deviates from predetermined limits during the Thread Engagement Phase 32, as compared to the historical pressure/torque values during Thread Engagement Phase 32, then the system/controller 30 may send a notification and/or automatically stop the coupling process. In one case if the mean and/or median of the measured pressure/torque during the Thread Engagement Phase 32 differs from the mean and/or median of historical pressure/torque of the Thread Engagement Phase by +/−10% in one case, or +/−20%, or differs by one standard deviation of the historical data of the pressure/torque in one case, or two standard deviations in another case, then the system/controller 30 may flag a faulty/improper coupling.

The threshold that is tracked at this stage (e.g. +/−10%, +/−20%, one standard deviation, or two standard deviations, etc.) can be termed the Thread Engagement Phase Threshold. With reference to FIG. 7, as an example, Thread Engagement Phase Average Pressure/Torque during the Thread Engagement Phase 32 is 500 psi, and if the Thread Engagement Phase Threshold is set to 10%, then the system/controller 30 can flag an improper coupling if measured mean and/or median pressure/torque values during the Thread Engagement Phase 32 exceeds 550 psi and/or drops below 450 psi.

In addition, the amount by which the Thread Engagement Phase Threshold is exceeded can be considered in determining if there is a faulty coupling. For example, in certain cases, if desired, as another check, a coupling process is considered to be proper unless a predetermined Check Value is exceeded a predetermined number of times (such as one, two, three or more times) during the Thread Engagement Phase 32. Thus, rather than considering the mean and/or median value (as in the example described above), the Check Value considers singular or instantaneous torque values. The numerical value assigned to the Check Value can in one case be related to the Thread Engagement Phase Threshold, and be, in one case, four times the Thread Engagement Phase Threshold, or 200 psi. However the Check Value can be, for example, double the Threaded Engagement Phase Threshold, or triple the Thread Engagement Phase Threshold, or 5× the Thread Engagement Phase Threshold, or in one case anywhere between 2× and 10× the Thread Engagement Phase Threshold (e.g. Check Value can be a factor or multiple of the Thread Engagement Phase Threshold, including fractions/decimal factors or multiples). If the measured torque values exceed the Check Value in this manner, it could be evidence of an instance of cross threading or dirty threads where the applied pressure would be overcoming irregular friction.

Besides being flagged as a faulty coupling, any electrode couplings that are flagged as exceeding the Thread Engagement Phase Threshold and/or the Check Value can be excluded from, and not included as part of, the Historical Database 44 since the electrode coupling can be considered faulty.

### Pressure/Torque Difference Percentage

The system/controller 30 can also track, calculate and/or monitor a Pressure/Torque Difference Percentage, which is a percentage of the difference between the Maximum End Face Phase Pressure/Torque 42 and the Thread Engagement Phase Average Pressure/Torque 35, as compared to the Maximum End Face Phase Pressure/Torque 42, as set forth in the following equation:

$$Pressure / Torque Difference Percentage = \frac{( Maximum End Face Phase Pressure / Torque - Thread Engagement Phase Average Pressure / Torque )}{Maximum End Face Phase Pressure / Torque} \times 100$$

Thus in the embodiment of FIG. 7, if the Maximum End Face Phase Pressure/Torque (at location 42) is 1950; and the Thread Engagement Phase Average Pressure/Torque is 500 psi, then the Pressure/Torque Difference Percentage is (1950 psi−500 psi)/1950 psi×100, for a value of 74.35%. The 74.35% value represents the percentage of total pressure applied during the End Face Engagement Phase 34; in other words, out of the total torque applied/achieved during the build (coupling process), in this case, 74.35% of that torque can be considered to have been applied during End Face Engagement 34.

If the Pressure/Torque Difference Percentage exceeds predetermined limits, as compared to the historical Pressure/Torque Difference Percentage, then the system/controller 30 may send a notification and/or automatically stop the coupling process. If the Pressure/Torque Difference Percentage differs from mean and/or median of the historical Pressure/Torque Difference Percentage by +/−10% in one case, or +/−20% in another case, or one standard deviation of the historical data of the Pressure/Torque Difference Percentage data in one case, or two standard deviations in another case, or is otherwise outside control limits based upon data or previously acceptable (historical) electrode couplings, then the system/controller 30 may flag a faulty/improper coupling. In other cases, if the Pressure/Torque Difference Percentage for a given build/coupling is lower than a predetermined value (e.g. the predetermined value can be 65% in one case, or 55% in another case, or 45% in yet another case), then the system/controller 30 may flag a faulty/improper coupling.

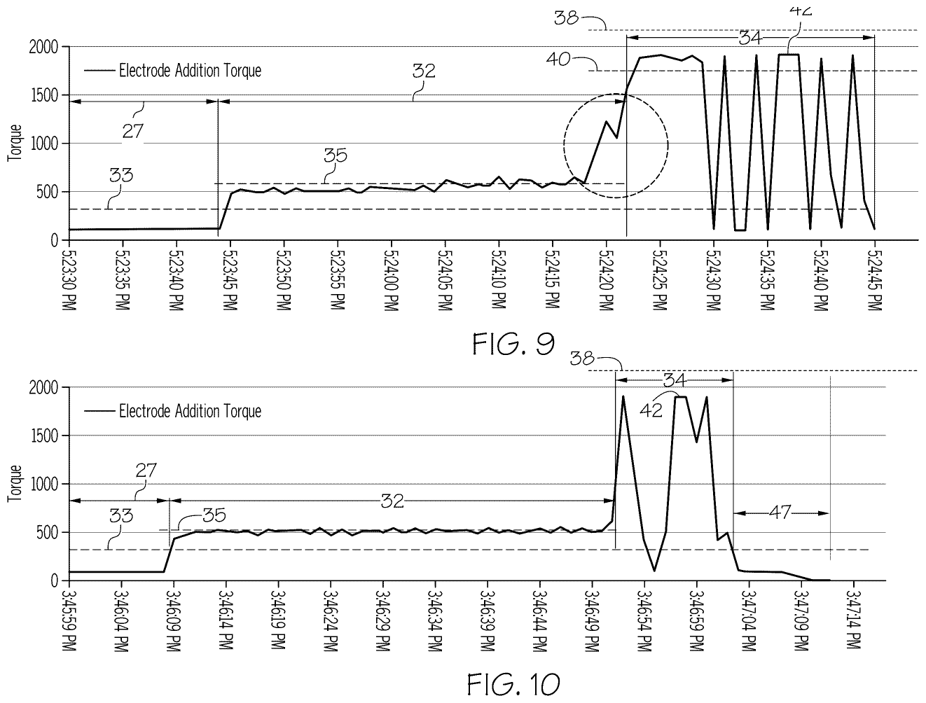

FIG. 9 shows an example of a coupling in which the Pressure/Torque Difference Percentage is used to flag a faulty/improper coupling. In the circled area of FIG. 9, it can be seen that there is a relatively slow rise in pressure as the system exits (but is still in) the Thread Engagement Phase 32, and the system then enters the End Face Engagement Phase 34. The relatively slow rise in pressure can be indicative of an obstruction on the threaded surfaces 20, 22 or other issues. The relatively slow rise in pressure thereby raises the Thread Engagement Phase Average Pressure/Torque 35, which in turn lowers the Pressure/Torque Difference Percentage sufficiently that the Pressure/Torque Difference Percentage threshold may be exceeded, and the coupling can be flagged as a faulty coupling.

In addition, besides being flagged as a faulty coupling, any electrode couplings that are flagged as exceeding the acceptable ranges for the predetermined Pressure/Torque Difference Percentage (e.g. falling outside two standard deviations of the historical values in one case), and/or that are flagged as falling below the predetermined value (e.g., falling below a value of 55% in one case), can be excluded from, and not included as part of, the Historical Database 44 since the electrode coupling can be considered faulty/improper.

### Thread Engagement Time

The system/controller 30 can also track, calculate and monitor the Thread Engagement Time, which is the time the system takes to complete the Thread Engagement Phase 32. In particular, if the measured Thread Engagement Time for a particular coupling differs from the mean and/or median historical Thread Engagement Time by +/−10% in one case, or +/−20% in another case, or one standard deviation of the historical data of the Thread Engagement Time in one case, or two standard deviations in another case, then the system/controller 30 may flag a faulty/improper coupling.

In one embodiment, rather than monitor the value of the Thread Engagement Time, the system/controller 30 can monitor the percent of the Thread Engagement Time compared to the Total Build Time. Thus, if the Thread Engagement Times, as a percentage of Total Build Time, differs from mean and/or median historical values by +/−10% in one case, or +/−15% in another case, or +/−20% in another case, or one standard deviation of the historical data in one case, or two standard deviations in another case, the coupling can be flagged as a faulty/improper coupling.

In one case, the system/controller may only flag/act upon Thread Engagement Times that are below thresholds for the historical Thread Engagement Times (e.g., the system may only flag Thread Engagement Times that are sufficiently short, and not necessarily flag those that are too long) since a sufficiently short Thread Engagement Time can be indicative of a thread obstruction which causes the sensed pressure/torque to rise and then fall. Thus in one case, Thread Engagement Times that are less than a predetermined percentage (less than 60% in one case, or less than 50% in another case) of the Total Build Time for that coupling/build time may be flagged. In addition, besides being flagged as a faulty coupling, any electrode couplings that are flagged as exceeding the acceptable range for the predetermined Thread Engagement Time(s) can be excluded from, and not included as part of, the Historical Database since the electrode coupling can be considered faulty/improper.

### End Face Engagement Time

The system/controller 30 can also track, calculate and monitor the End Face Engagement Time, which is the time the system takes to complete the End Face Engagement Phase 34. In particular, if the measured End Face Engagement Time for a particular coupling differs from the mean and/or median of historical End Face Engagement Time by +/−10% in one case, or +/−15% in another case, or +/−20% in another case, or one standard deviation of the historical data of the End Face Engagement Time in one case, or two standard deviations in another case, then the system/controller 30 may flag a faulty/improper coupling.

In one embodiment, rather than monitor the value of the End Face Engagement Time itself, the system/controller can monitor the percent of the End Face Engagement Time compared to the Total Build Time. Thus, in one case, End Face Engagement Times that are not, for example, within +/−15% of the mean and/or median in one case, or within +/−25% of the mean and/or median in another case, of the historical percent of the End Face Engagement Time as compared to Total Build Time, or within one standard deviation of the historical data, or within two standard deviations, may be flagged as a faulty/improper coupling.

The system/controller may flag/act upon End Face Engagement Times that are outside thresholds for the historical End Face Engagement Times (e.g., the system may flag End Face Engagement Times that are sufficiently short) since a sufficiently short End Face Engagement Time can be indicative that the operator has not sufficiently “bumped” the electrodes 12, 14, which can lead to a faulty/improper coupling. FIG. 10 is illustrative of a faulty electrode coupling due to a sufficiently short End Face Engagement Time. In the embodiment of FIG. 10, the time in the End Face Engagement Phase 34 is about twelve seconds, and the Total Build Time is about fifty four seconds, and thus the End Face Engagement is about 22% of the Total Build Time, and thus can be flagged as being too short.

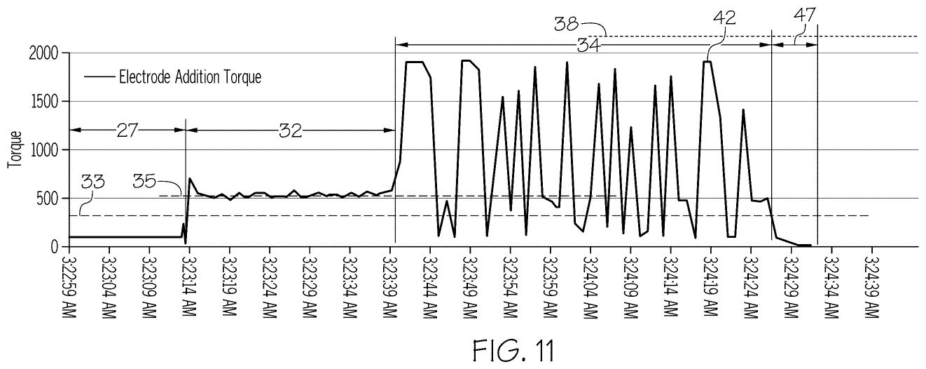

The system/controller may also flag/act upon End Face Engagement Times 34 that are above thresholds for the historical End Face Engagement Times (e.g., the system may flag End Face Engagement Times that are sufficiently long,) since a sufficiently long End Face Engagement Time can be indicative of cross threading, misalignment, or that the operator has not followed proper coupling procedure, which can lead to a faulty coupling. In addition, sufficiently long End Face Engagement Times can be indicative of excessive bumping, which can cause undue stress on the coupling device 10 and/or the electrodes 12, 14. FIG. 11 is illustrative of a faulty electrode coupling due to a sufficiently long End Face Engagement Time. In the embodiment of FIG. 11, the End Face Engagement Time 34 is about forty seven seconds, and the Total Build Time is about seventy four seconds, and thus the End Face Engagement is about 64% of the Total Build Time, and thus can be flagged as being too long, relatively speaking.

In addition, besides being flagged as a faulty/improper coupling, any electrode couplings that are flagged as exceeding the acceptable range(s) for the predetermined End Face Engagement Time can be excluded from, and not included as part of, the Historical Database since the electrode coupling can be considered faulty.

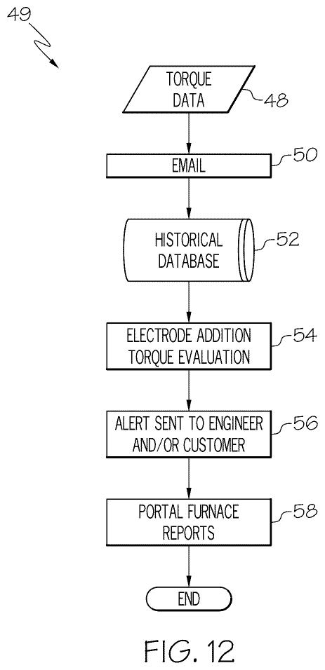

An overview of the process/method 49 is provided in FIG. 12, where the process begins with compilation of pressure/torque data from proper coupling, at step 48, e.g. for inclusion in the Historical Database 44. The compiled data is then sent, at step 50 (via email in one case) and received at a database (step 52) which in one case can constitute or overlap with the historical database 44. Next, at step 54, received data for a particular build/coupling, and historical data, is evaluated, for example carrying out the various calculations and evaluations outlined above. The results of step 54 may result in detection of an improper (or proper) coupling, which results in an alert sent to the operator/engineer and/or the customer at step 56. The results of the step 54 can also be fed to the controller 30 or the like that can generate reports detailing the furnace/electrode coupling (including graphs like those shown in FIGS. 7-11, and results of the various parameters and calculations described above) and operation performance, at step 58.

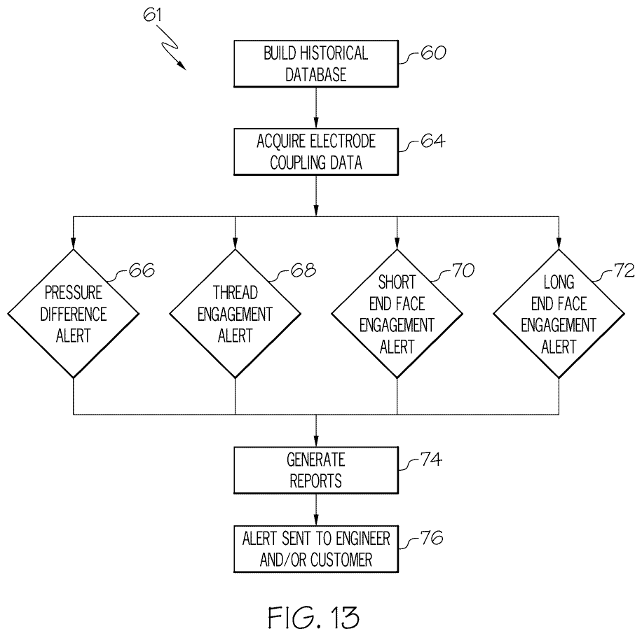

With reference to FIG. 13, an exemplary environment 61 is illustrated of a system that can include a database of baseline build data/database 60, which can constitute or overlap with the historical database 44. The data of a particular build or electrode coupling is acquired at step 64. The acquired data is then compared to the Historical Database 44 in the manner outlined above. In the embodiment of FIG. 13, the system sends alerts when the Pressure/Torque Difference Percentage is exceeded at block 66, and/or when the Thread Engagement time is too short at block 68, and/or when the End Face Engagement Time is too short at block 70, and/or when the End Face Engagement Time is too long at block 72. Each of these alerts (and/or alerts triggered by exceeding/falling below the other parameters outlined above) can be documented in a report at step 74 and/or result in an alert sent to the operator/engineer and/or the customer at step 76.

The system and method disclosed herein can help furnace operators quickly detect and resolve improper/faulty electrode builds, which can reduce downtime of the furnace and provide more efficient operations. The furnace operations can have a higher confidence level in electrode builds not determined to be improper, and the system and method can reduce joint breaks in the electrode column 17.

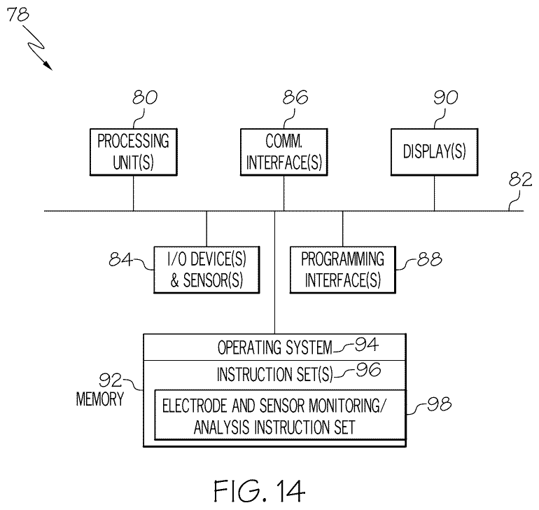

FIG. 14 is a block diagram of an example device 78, such as a computer system or controller for executing the software components described herein for the sending/receiving and processing of tasks. Device 78 illustrates an exemplary device or computer configuration for devices, computers, controllers, etc. described herein (e.g., controller 30 or the like). While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 78 includes one or more processing units 80 (e.g., microprocessors, ASICs, FPGAs, GPUs, CPUs, processing cores, and/or the like), one or more input/output (I/O) devices and sensors 84, one or more communication interfaces 86 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 88, one or more displays 90, a memory 92, and one or more communication buses 82 for interconnecting these and various other components.

In some implementations, the one or more communication buses 82 include circuitry that interconnects and controls communications between system components. In some implementations, the one or more I/O devices and sensors 84 include at least one of a pressure sensor, a voltage sensor, a current sensor and/or the like. In some implementations, the one or more displays 90 are configured to present a view of input data, output data, system status data, or a physical environment or a graphical environment to the user.

The memory 92 includes high-speed random-access memory, such as DRAM, SRAM, DDR RAM, or other random-access solid-state memory devices. In some implementations, the memory 92 includes non-volatile memory, such as one or more magnetic disk storage devices, optical disk storage devices, flash memory devices, or other non-volatile solid-state storage devices. The memory 92 optionally includes one or more storage devices remotely located from the one or more processing units 80. The memory 92 includes a non-transitory computer readable storage medium.

In some implementations, the memory 92 or the non-transitory computer readable storage medium of the memory 92 stores an optional operating system 94 and one or more instruction set(s) 96. The operating system 94 includes procedures for handling various basic system services and for performing hardware dependent tasks. In some implementations, the instruction set(s) 96 include executable software defined by binary information stored in the form of electrical charge. In some implementations, the instruction set(s) 96 are software that is executable by the one or more processing units 80 to carry out one or more of the techniques described herein.

The instruction set(s) 96 include an electrode and sensor monitoring/analysis instruction set 98. The instruction set(s) 96 may be embodied a single software executable or multiple software executables.

In some implementations, the electrode and sensor monitoring/analysis instruction set 98 is executable by the processing unit(s) 80. The electrode and sensor monitoring/analysis instruction set 98 may be configured to receive output torque values relating to the applied torque, analyze the received torque values to identify a thread engagement phase during which a first electrode is being threadedly coupled to a second electrode, and to identify an end face engagement phase during which an end face of the first electrode contacts an end face of the second electrode, and carry out the various other calculations described above. To these ends, in various implementations, the instruction includes instructions and/or logic therefor, and heuristics and metadata therefor.

Although the instruction set(s) 96 are shown as residing on a single device, it should be understood that in other implementations, any combination of the elements may be located in separate computing devices. Moreover, FIG. 14 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically includes computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce or result in a device or an article of manufacture including instructions that implement the functions/acts specified in the flowcharts, sequence diagrams, and/or block diagrams shown and described herein. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a,” “an” and “the” are intended to include the plural forms as well, unless the context clearly indicates otherwise. It will be further understood that the terms “comprises” and/or “comprising,” when used herein, specify the presence of stated features, integers, steps, operations, elements, and/or components, but do not preclude the presence or addition of one or more other features, steps, operations, elements, components, and/or groups thereof. Furthermore, to the extent that the terms “includes,” “having,” “has,” “with,” “comprised of,” or variants thereof are used in either the detailed description or the claims, such terms are intended to be inclusive in a manner similar to the term “comprising.”

While invention has been illustrated by a description of various embodiments and while these embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the general inventive concept.

Having described the invention in detail and by reference to certain embodiments thereof, it will be apparent that modifications and variations are possible without departing from the scope of the invention which is defined in the appended claims.

What is claimed is:

1. An electrode coupling monitoring system for use with a device configured to apply torque to a first electrode to threadedly couple the first electrode to a second electrode, the device being configured to output torque values relating to an applied torque, the system comprising:
a controller configured to:
receive torque values;
analyze the received torque values to identify a thread engagement phase during which the first electrode is or was being threadedly coupled to the second electrode; and
identify an end face engagement phase during which an end face of the first electrode contacts or contacted an end face of the second electrode.

2. The system of claim 1 wherein the controller is configured to identify the thread engagement phase by determining that the received torque values exceed a predetermined value.

3. The system of claim 2 wherein the controller is configured to identify a beginning of the thread engagement phase by determining that the received torque values exceed the predetermined value, wherein the controller is configured to identify an end of the thread engagement phase by identifying a beginning of the end face engagement phase.

4. The system of claim 2 wherein the controller is configured to identify a coupling as a faulty coupling if, during the thread engagement phase, the received torque values exceed a check value a predetermined number of times, wherein the check value is a factor of the predetermined value.

5. The system of claim 1 wherein the controller is configured to identify the end face engagement phase by determining the received torque values are within a predetermined percentage of a maximum torque that can be applied by the device.

6. The system of claim 5 wherein the controller is configured to identify a beginning of the end face engagement phase by determining that the received torque values are within the predetermined percentage, wherein the controller is configured to determine an end of the thread engagement phase that corresponds to when the end face engagement phase begins, and wherein the controller is configured to determine an end of the end face engagement phase when the received torque values fall below a predetermined minimum value, and thereafter remain below the predetermined minimum value for a predetermined period of time.

7. The system of claim 1 wherein the controller is configured to determine a torque difference percentage, which is a percentage difference between a maximum torque value during the end face engagement phase and an average torque during the thread engagement phase, and to compare the determined torque difference percentage to a historical torque difference percentage value or values.

8. The system of claim 7 wherein the controller is configured to send a notification if the determined torque difference percentage deviates sufficiently from the historical torque difference percentage value or values.

9. The system of claim 8 wherein the controller is configured such that, the determined torque difference percentage sufficiently deviates from the historical torque difference percentage value or values, if the determined torque difference percentage deviates from at least one of the mean or median of the historical torque difference percentage by at least 10%.

10. The system of claim 7 wherein the controller is configured such that the historical torque difference percentage is determined by taking into consideration historical torque difference percentage values for couplings that are determined to be proper and by not taking into consideration torque difference percentage values for couplings determined to be improper.

11. The system of claim 1 wherein the controller is configured to determine improper coupling operations as those in which a torque difference, which is the difference between a maximum torque value during the end face engagement phase and an average torque during the thread engagement phase, divided by the maximum torque value during the end face engagement phase, is less than 55%.

12. The system of claim 1 wherein the controller is configured to determine a time of the thread engagement phase, and to send a notification when the determined time of the thread engagement phase deviates sufficiently from at least one of a mean or median of a historical value of the thread engagement phase time.

13. The system of claim 1 wherein the controller is configured to determine a time of the thread engagement phase and a total build time, which is the time of the thread engagement phase plus a time of the end face engagement phase, wherein the controller is configured to determine a percentage of the time of the thread engagement phase compared to the total build time, and wherein the controller is configured to send a notification when the determined percentage of the time of the thread engagement phase is sufficiently low compared to at least one of a mean or a median of a historical value of the percentage of the time of the thread engagement phase.

14. The system of claim 13 wherein the controller is configured to exclude, from the historical value of the thread engagement time, any thread engagement phase times determined to be from improper coupling operations.

15. The system of claim 1 wherein the controller is configured to determine a time of the end phase engagement phase, and to send a notification when the determined time of the end face engagement phase deviates sufficiently from at least one of a mean or a median of a historical value of the end face engagement phase time.

16. The system of claim 1 wherein the controller is configured to determine a time of the end face engagement phase and a total build time, which is a time of the thread engagement phase plus the time of the end face engagement time, wherein the controller is configured to determine a percentage of the end face engagement phase time compared to the total build time, and wherein the controller is configured to send a notification when the determined percentage of the end face engagement time deviates sufficiently compared to at least one of a mean or a median of a historical value of the percentage of the end face engagement phase time compared to the total build time.

17. The system of claim 16 wherein the controller is configured to exclude, from the historical value of the end face engagement time, any thread engagement phase times determined to be from improper coupling operations.

18. The system of claim 1 wherein the device includes a sensor configured to sense the torque applied by the device to the first electrode to provide the output torque values, wherein the controller includes one or more processors, wherein the controller is configured to cause the device to stop applying any torque when the controller detects an improper coupling operation, and wherein the controller is configured to add, to a historical database, torque data for couplings determined to be proper couplings.

19. The system of claim 18 further comprising the device configured to apply torque, and wherein the sensor measures at least one of pressure of a hydraulic fluid, electrical current or electrical voltage.

20. An electrode coupling monitoring system for use with a device configured to apply torque to a first electrode to threadedly couple the first electrode to a second electrode, the device being configured to output torque values relating to the applied torque, the system comprising:
a controller comprising one or more processors;
at least one memory device operatively coupled to the controller; and
a data communications interface operably associated with the controller, wherein the at least one memory device contains a plurality of program instructions that, when executed by the controller, cause the controller to:
receive torque values;
analyze the received torque values to identify a thread engagement phase during which the first electrode was or is being threadedly coupled to the second electrode; and
identify an end face engagement phase during which an end face of the first electrode contacted to contacts an end face of the second electrode.

21. A method for monitoring an electrode coupling process comprising:
receiving, from a device configured to apply torque to a first electrode to threadedly couple the first electrode to a second electrode, or from an associated sensor, output torque values relating to the applied torque; and
analyzing the received torque values to identify a thread engagement phase during which the first electrode was or is being threadedly coupled to the second electrode, and to identify an end face engagement phase during which an end face of the first electrode contacted or contacts an end face of the second electrode.

22. Computer readable instructions stored on a non-transitory storage medium that are configured, when read and processed by a controller, to cause the controller to:
receive, from a device configured to apply torque to a first electrode to threadedly couple the first electrode to a second electrode, or from an associated sensor, output torque values relating to the applied torque; and
analyze the received torque values to identify a thread engagement phase during which the first electrode was or is being threadedly coupled to the second electrode, and to identify an end face engagement phase during which an end face of the first electrode contacted or contacts an end face of the second electrode.
